(19) United States
(12) Patent Application Publication
(10) Pub. No.: US 2016/0124591 A1
(43) Pub. Date: May 5, 2016

(54) ITEM SELECTION APPARATUS AND ITEM SELECTION METHOD

(71) Applicant: DENSO CORPORATION, Aichi (JP)

(72) Inventors: Shinsuke HISATSUGU, Kariya-city (JP); Motoki TACHIIRI, Nagoya-city (JP); Nobuaki KAWAHARA, Nisshin-city (JP)

(73) Assignee: DENSO CORPORATION, Kariya-city, Aichi-pref. (JP)

(21) Appl. No.: 14/892,503

(22) PCT Filed: May 20, 2014
(86) PCT No.: PCT/JP2014/002634

§ 371 Date: Nov. 19, 2015

(30) Foreign Application Priority Data
May 23, 2013 (JP) 2013-109181

(51) Int. Cl. G06F 3/0482; G06F 3/0485; G06F 3/0484

(52) U.S. Cl. CPC G06F 3/0482; G06F 3/04842; G06F 3/0485; G06F 3/04847

(57) ABSTRACT

An item selection apparatus storing multiple items being classified into multiple groups, and selecting a desired item on a display screen by displaying the multiple items on the display screen and by changing a group with which the items are displayed, is provided. The item selection apparatus includes an operation portion, a selection candidate display portion, a selection candidate change portion, a determination portion, and a group change portion. The operation portion has a predetermined reference position and is rotated from the reference position. The selection candidate display portion displays an item of a selection candidate in a mode different from another item. The selection candidate change portion changes the item at a speed corresponding to a rotational angle. The determination portion determines the item as a selected item. The group change portion changes the group with which the multiple items are displayed on the display screen.

### CROSS-REFERENCE TO RELATED APPLICATION

The present application is based on Japanese Patent Application No. 2013-109181, filed on May 23, 2013, the disclosure of which is incorporated herein by reference.

### TECHNICAL FIELD

The present disclosure relates to an item selection apparatus with which a user selects an item. More particularly, the present disclosure relates to a technique to cause a user to select a predetermined item from multiple items displayed on a display screen such as a display.

### BACKGROUND ART

A device includes a function displaying multiple items on a display screen and causing a user to select a desired item. For example, an audio device displays multiple song titles and causes the user to select a desired song. A navigation device displays multiple place names and causes the user to select a desired place name. In such a device, when there are a number of selectable items, it may be difficult for the user to find a desired item, and a burden on the user may increase.

Thus, various techniques have been proposed in order to reduce such a burden on the user. For example, items are classified into multiple groups according to a predetermined condition (for example, according to a first letter of item names) in advance, and the multiple displayed groups are sequentially exhibited one by one as a selection candidate. When the user makes a predetermined selection operation, a displayed group is selected as the selection candidate, and multiple items classified into the selected group are displayed. Thus, when the user performs a predetermined scroll operation while items in the group are displayed, the items in the group are displayed by scrolling, and the multiple displayed items are sequentially exhibited as a selection candidate. According to this configuration, it may be possible for the user to find and select a desired item without difficulty even when the number of items is increased (referring to Patent document 1).

The inventors of the present application have found the following. According to the proposed technique, it may not reduce sufficiently a burden on the user when the user selects an item. More specifically, when shifting between an operation to display groups sequentially as a selection candidate and an operation to display items sequentially as a selection candidate, it may be necessary for the user to make an extra operation for changing a subject (a group or an item) to be displayed as a selection candidate. The user may feel an extra operation is bothersome.

### PRIOR ART DOCUMENT

### Patent Document

Patent document 1: JP 2002-140143 A

### SUMMARY OF THE INVENTION

It is an object of the present disclosure to provide a technique enabling to reduce a burden on a user when the user selects an item.

An item selection apparatus and an item selection method of the present disclosure store multiple items being classified into multiple groups, and select a desired item on a display screen by displaying the multiple items on the display screen and by changing a group with which the items are displayed, is provided. The item selection apparatus and the item selection method display an item of a selection candidate among the multiple items displayed on the display screen in a mode different from other items. When the operation portion is displaced from the reference position, the item selection apparatus and the item selection method change the item of the selection candidate displayed on the display screen at a speed corresponding to a displacement amount from the reference position. When a predetermined determination operation is made while the operation portion is at the reference position, the item selection apparatus and the item selection method determines the item of the selection candidate as a selected item. When the displacement amount of the operation portion from the reference position exceeds a predetermined threshold amount of displacement, the item selection apparatus and the item selection method change the group with which the multiple items are displayed on the display screen.

According to the item selection apparatus and the item selection method, by increasing a displacement amount of an operation portion, a change speed of an item of a selection candidate increases. When the displacement amount of the operation portion exceeds a predetermined threshold amount of displacement, a group with which multiple items are displayed on the display screen is changed. Therefore, it may be possible for a user to switch a subject to be changed from an item of a selection candidate to a group with which multiple items are displayed on the display screen, by merely continuing an operation to increase a changing speed of the selection candidate (an operation to increase an displacement amount of the operation portion) without performing any extra operation. In addition, it may be possible to cause the user to feel that a group with which multiple items are displayed on the display screen is changed in a process of increasing a changing speed of the items of the selection candidate. Accordingly, it may be possible to change items of the selection candidate smoothly and intuitively, and it may be possible to reduce a burden on the user when selecting an item.

### BRIEF DESCRIPTION OF THE DRAWINGS

The above and other objects, features, and advantages of the present disclosure will become more apparent from the following detailed description with reference to the accompanying drawings, in the drawings:

FIG. 1 is a diagram illustrating a configuration of an item selection apparatus;

FIG. 2 is a diagram illustrating a concept of music data stored in a portable storage medium;

FIG. 3A is a diagram illustrating a concept of hierarchical data generated by a CPU;

FIG. 3B is a diagram illustrating a first example describing the hierarchical data of a hierarchical structure in which song titles are classified into middle classifications and large classifications;

FIG. 3C is a diagram illustrating a second example describing the hierarchical data of a hierarchical structure in which song titles are classified into middle classifications and large classifications ;

FIG. 4 is a perspective view illustrating a selection operation portion;

FIG. 5 is a diagram exemplifying contents that are displayed on a display;

FIG. 6 is a flowchart illustrating item selection processing performed by the CPU;

FIG. 7 is a flowchart illustrating processing during scrolling display suspension performed by the CPU;

FIG. 8 is a diagram illustrating a rotational angle of the selection operation portion;

FIG. 9 is a diagram illustrating an example of a manner when song titles are displayed on the display by scrolling;

FIG. 10 is a flowchart illustrating processing during song title scrolling display performed by the CPU;

FIG. 11 is a diagram illustrating an example in which middle classifications (a first letter) are displayed on the display by scrolling;

FIG. 12 is a flowchart illustrating processing during middle classification scrolling display performed by the CPU;

FIG. 13 is a diagram illustrating an example in which large classifications (a first line) are displayed on the display by scrolling; and

FIG. 14 is a flowchart illustrating processing during large classification scrolling display performed by the CPU.

### PREFERRED EMBODIMENTS FOR CARRYING OUT THE INVENTION

An embodiment of an item selection apparatus will be described so as to make contents of the present disclosure clear. An item selection apparatus 10 of the present embodiment is mounted to a vehicle and includes a function to playback songs. In addition, the item selection apparatus 10 serves as a device to let a user select a song title.

(Device Configuration)

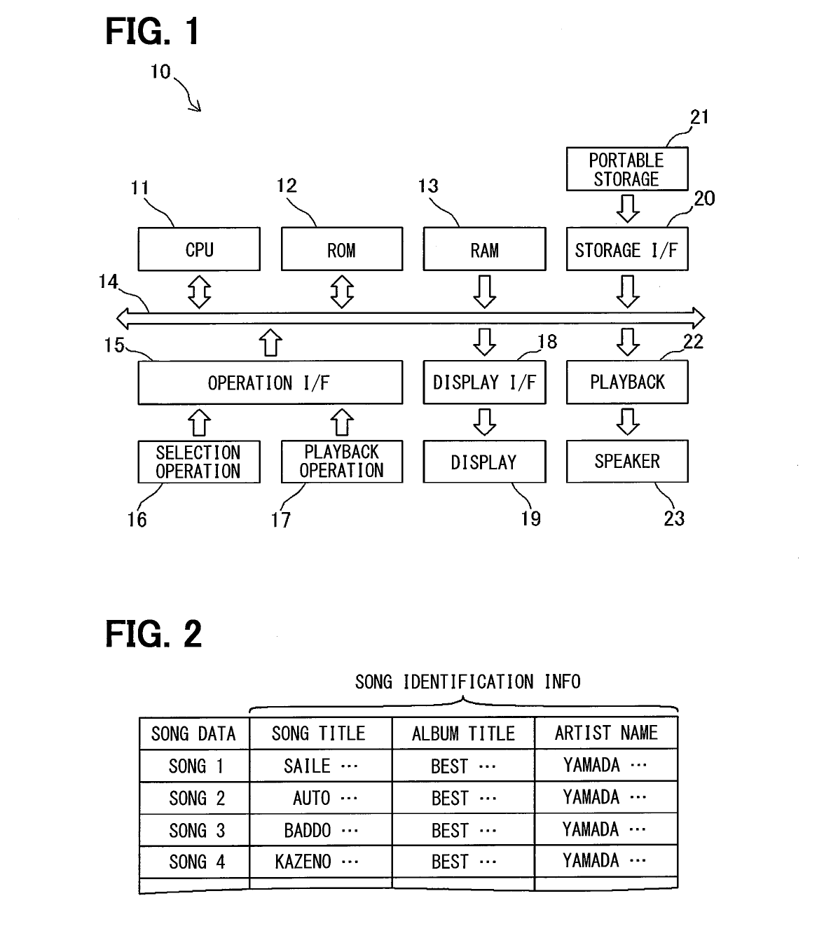

FIG. 1 shows a configuration of the item selection apparatus 10. As described in FIG. 1, in the item selection apparatus 10 in the present embodiment, a CPU 11 as a main component, a ROM 12 that stores a program run by the CPU 11, a RAM 13 that stores a work area of the CPU 11 and a hierarchical data, or the like are connected through a bus 14.

A playback operation portion 17 and a selection operation portion 16 (corresponding to an operation portion of the present disclosure) are also connected to the bus 14 through an operation interface 15. The playback operation portion 17 is a push-button type operation portion by which the user starts or stops playing a song. The selection operation portion 16 is a rotatable operation portion by which the user selects a song title. The selection operation portion 16 will be described in detail below.

A display 19 is connected to the bus 14 through a display interface 18. Information for causing the user to select a song title or a title of the song playing is displayed on the display 19 (corresponding to a display screen). Furthermore, a storage medium interface 20 is connected to the bus 14. A portable storage medium 21 such as a portable media player is connected to the storage medium interface 20. The portable storage medium 21 stores multiple song data in a predetermined compression format in advance. The user (for example, a driver) connects the portable storage medium 21 to the storage medium interface 20. A song playback portion 22 is connected to the bus 14, and an output of the song playback portion 22 is connected to a speaker 23. The song playback portion 22 includes a DSP, a DAC, or the like. The song playback portion 22 plays a song by successively outputting song data stored in the portable storage medium 21 to the speaker 23 after the song data is decompressed and converted from a digital form to an analog form.

FIG. 2 shows a concept of song data stored in the portable storage medium 21. As illustrated in FIG. 2, each song data stored in the portable storage medium 21 is correlated with song identification information that illustrates a song title, an album title, and an artist name. When the user connects the portable storage medium 21 to the storage medium interface 20, the CPU 11 generates hierarchical data that is stored to a predetermined address in the RAM 13. Incidentally, the hierarchical data is data for displaying on the display 19, a song title selectable by the user and a classification (corresponding to a group of the present disclosure) to which the song title belongs.

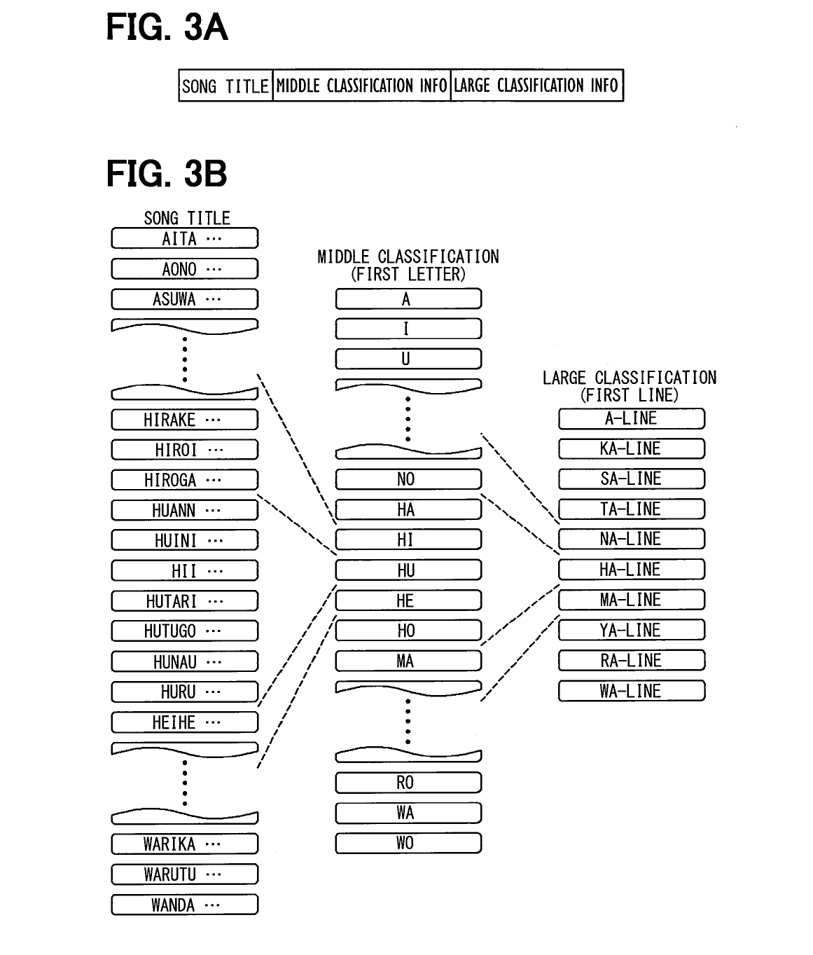

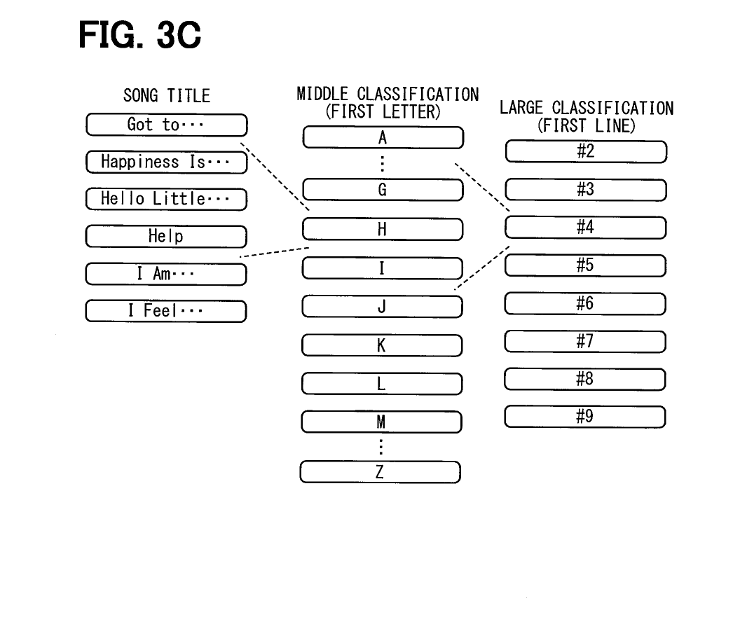

FIG. 3A, FIG. 3B, and FIG. 3C illustrate concepts of the hierarchical data generated by the CPU 11. When the portable storage medium 21 is connected to the storage medium interface 20, the CPU 11 initially reads out a song title from the song identification information (referring to FIG. 2) stored in the portable storage medium 21. As is shown in FIG. 3A, each song title is stored in correlation with middle classification information and large classification information. The middle classification information and the large classification information respectively are data to classify a song title into a middle classification and a large classification. In the present embodiment, a first letter of a song title is set as the middle classification, and “a line” (a first line) of Japanese 50 phonetic sounds to which a first letter of the song title belong is set as the large classification. By correlating all song titles stored in the portable storage medium 21 with the middle classification information and the large classification information, a hierarchical structure as shown in FIG. 3B and FIG. 3C in which all song titles are divided into the middle classifications and the large classifications is stored as the hierarchical data. Hereinafter, when a song title, a middle classification (a first letter), and a large classification (a first line) are not particularly distinguished, all are collectively referred to as a rank.

Incidentally, “lines” of Japanese 50 phonetic sounds are one of rules relating to Japanese KANA letters. Japanese 50 phonetic sounds are divided into ten lines (“A-line”, “HA-line”, or the like). The “HA-line” is made up of five phonetic sounds (HA, HI, HU, HE, HO). FIG. 3C shows that each song title is stored in correlation with the middle classification information and the large classification information using the alphabet. FIG. 3C shows an alphabet allocation to the key arrangement on a phone as an example. It should be appreciated that a manner of setting middle classifications and large classifications is not limited to the manner described in the present embodiment and the ranks may be set appropriately to each language.

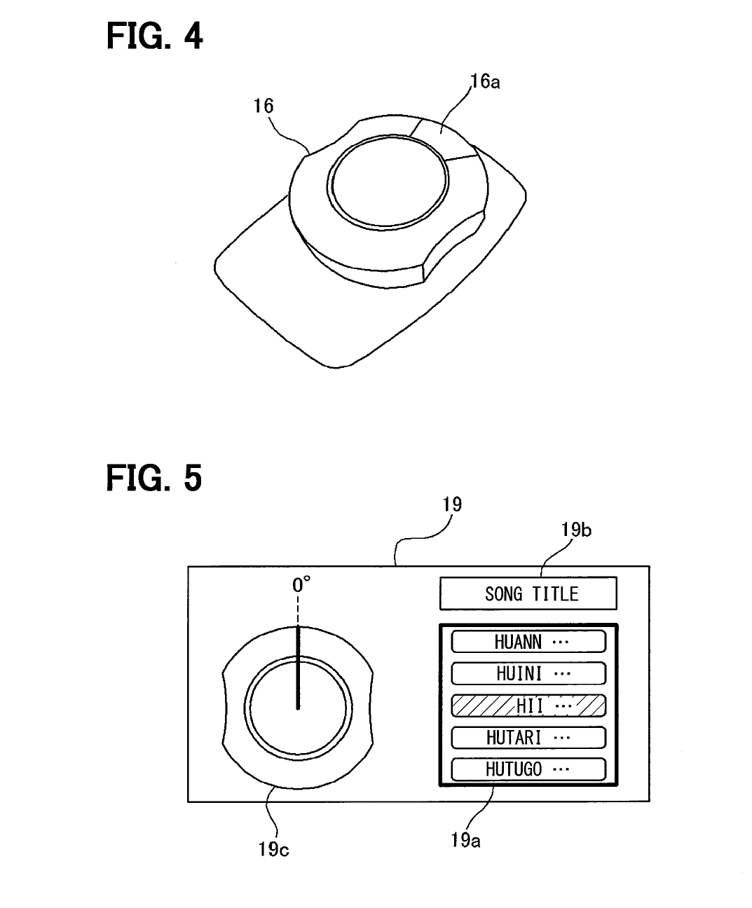

FIG. 4 is a perspective view of the selection operation portion 16. The selection operation portion 16 is an operation portion that the user operates when selecting a song title. The selection operation portion 16 has a disc-shaped movable portion that is rotated by the user, and is provided near a driver seat in a vehicle. By using the selection operation portion 16, when the user operates the selection operation portion 16, an amount of displacement of the selection operation portion 16 (for example, a rotational angle) may be correlated with an amount of twist of the wrist. Thus, in comparison with a case where an operation portion is merely moved linearly, it may be possible for the user to feel the amount of displacement (the rotational angle) of the selection operation portion 16 more easily.

A determination button 16a that is a press type is provided to a part of an upper surface of the selection operation portion 16. The user depresses the determination button 16a when the user finalizes a selection of a song title.

FIG. 5 shows an example of contents displayed on the display 19. The item selection apparatus 10 of the present embodiment displays any one of song titles, middle classifications (first letters), and large classifications (first lines) by scrolling according to the rotational angle of the selection operation portion 16. The display 19 includes two regions. One is a region (corresponding to a scroll display region) 19a in which any one of the song titles, the middle classifications, and the large classifications is displayed by scrolling. The other is a region (corresponding to a rank display region) 19b in which the rank being displayed is displayed by scrolling.

In addition, an image 19c that indicates the rotational angle from a reference position of the selection operation portion 16 is displayed on the display 19. According to this configuration, it may be possible for the user to readily adjust the rotational angle of the selection operation portion 16 without seeing the selection operation portion 16 by looking away from the display 19. In an example in FIG. 5, the rotational angle of the selection operation portion 16 is 0 degrees. When the rotational angle of the selection operation portion 16 is 0 degrees, the selection operation portion 16 is at the reference position.

(Item Selection Processing)

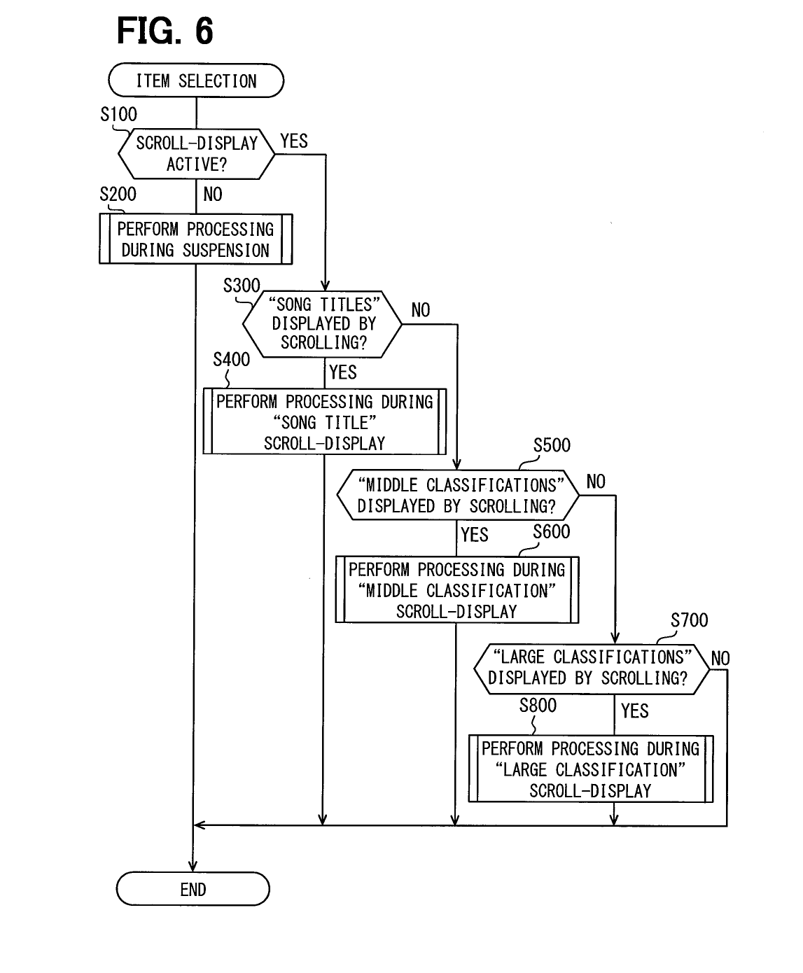

FIG. 6 is a flowchart illustrating item selection processing performed by the CPU 11. The item selection processing is started after the hierarchical data as exemplified in FIG. 3A, FIG. 3B, and FIG. 3C is generated, and thereafter is performed each predetermined time (for example, four milliseconds) as timer interruption processing. When the CPU 11 starts the item selection processing, the CPU 11 initially determines whether a scroll display of song titles is performed (S100). In the item selection apparatus 10 of the present embodiment, as described in FIG. 5, the scroll display of the song titles is suspended when the rotational angle of the selection operation portion 16 from the reference position is 0 degrees (when the selection operation portion 16 is at the reference position). Therefore, the CPU 11 determines in S100 whether the scroll display of the song titles is performed based on whether the selection operation portion 16 is positioned to the reference position. When it is determined that the scroll display of the song titles is not performed (S100: NO), the CPU 11 performs processing while the scroll display is suspended (processing during scroll display suspension). Incidentally, a state in which the scroll display of the song titles is not performed corresponds to a state in which the scroll display is suspended.

(Processing during Scroll Display Suspension)

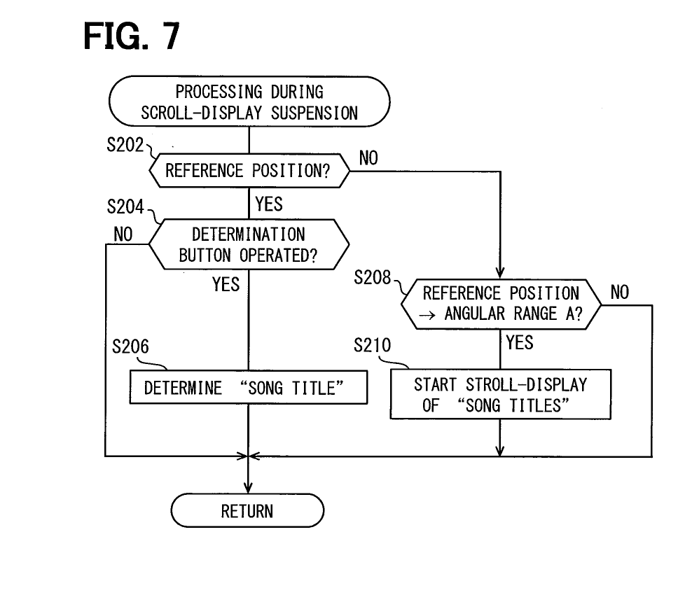

FIG. 7 is a flowchart illustrating the processing during the scroll display suspension. When the CPU 11 begins the processing during the scroll display suspension, the CPU 11 initially determines whether the selection operation portion 16 is positioned at the reference position (S202). When the selection operation portion 16 is positioned at the reference position, the CPU 11 determines whether the determination button 16a is operated (S204). When the determination button 16a is operated (S204: YES), the CPU 11 finalizes a selection of a song title being displayed as a selection candidate (S206). In the item selection apparatus 10 of the present embodiment, when the scroll display of the song titles is suspended, one of the song titles being displayed is exhibited as a selection candidate by displaying the one song title in a color different from the rest of the song titles, as is indicated by a slant line hatching in FIG. 5. In S206, a selection of the song title (of a selection candidate) being displayed as the selection candidate is determined.

When the CPU 11 determines in S204 that the determination button 16a is not operated (S204: NO), the CPU 11 maintains the scroll display of the song titles under suspension.

Thus, in the item selection apparatus 10 of the present embodiment, a selection of a song title as a selection candidate is finalized when the determination button 16a is operated while the selection operation portion 16 is at the reference position. Incidentally, when the selection of a song title is finalized, the CPU 11 transmits the song title to the song playback portion 22. Upon receipt of the song title, the song playback portion 22 reads out song data corresponding to the song title from the portable storage medium 21, and plays the song by outputting the song data from the speaker 23 after decompression and amplification.

When the CPU 11 determines in S202 that the selection operation portion 16 is not positioned at the reference position (S202: NO), the CPU 11 determines whether the selection operation portion 16 is rotated from the reference position to an angular range A (S208).

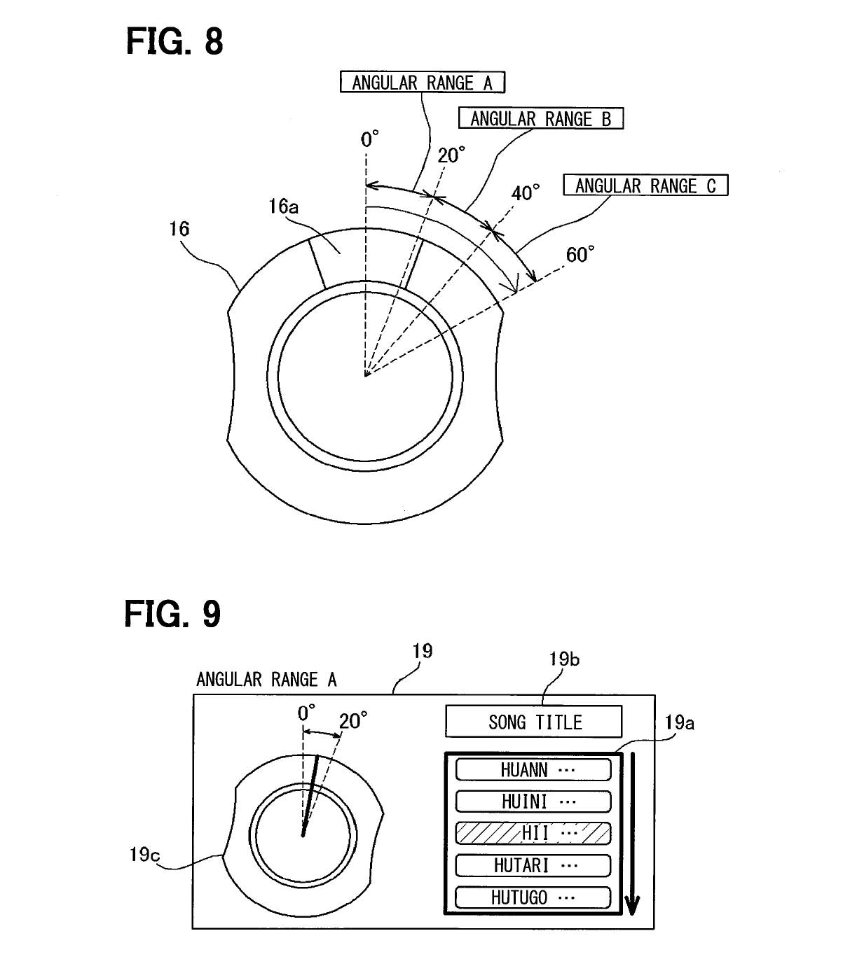

FIG. 8 illustrates rotational angles of the selection operation portion 16. As is shown in FIG. 8, the selection operation portion 16 is rotatable from the reference position (0 degrees) up to 60 degrees. The CPU 11 is capable of determining whether the rotational angle of the selection operation portion 16 is within a range of greater than the reference position (0 degrees) to less than 20 degrees (corresponding to the angular range A), a range of 20 degrees or greater to less than 40 degrees (corresponding to an angular range B), or a range of 40 degrees or greater to 60 degrees or less (corresponding to an angular range C).

When the CPU 11 determines in S208 of FIG. 7 that the selection operation portion 16 is rotated from the reference position to the angular range A (S208: YES), the CPU 11 starts to perform a scroll display of the song titles by referring to the hierarchical data (see FIG. 3A, FIG. 3B, and FIG. 3C) (S210).

FIG. 9 shows an example in which the song titles are displayed on the display 19 by scrolling. During the scroll display of the song titles, as is shown in the drawing, the song titles are displayed by scrolling in the scroll display region 19a. The rank displayed by scrolling, which is “song titles”, is displayed in the rank display region 19b. During the scroll display of the song titles, the song titles displayed in the scroll display region 19a are successively changed, and a song title (a slant line hatched song title”) displayed as a selection candidate is changed one after another. In addition, the image 19c indicating that the rotational angle of the selection operation portion 16 is within the angular range A is also displayed on the display 19. When the last song title (a song title of the song titles in the lowermost parts of FIG. 3B and FIG. 3C) is displayed by scrolling (displayed as a selection candidate), the display returns to the first song title (a song title of the song titles in the uppermost parts of FIG. 3B and FIG. 3C) and the following song titles are displayed by scrolling (displayed as a selection candidate).

The processing while the scroll display of the song titles is suspended (the processing during the scroll display suspension) is described. By contrast, when the scroll display of the song titles is performed (S100 of FIG. 6: YES), the CPU 11 determines whether the song titles are displayed by scrolling (S300). Incidentally, a case in which the scroll display of the song titles is performed corresponds to a case in which the scroll display of the song titles is not suspended. As described above, in the item selection apparatus 10 of the present embodiment, the scroll display of the song titles is started when the selection operation portion 16 is rotated from the reference position to the angular range A. The scroll display of the song titles is continued while the selection operation portion 16 is within the angular range A. The CPU 11 determines in S300 whether the song titles are displayed by scrolling based on whether the selection operation portion 16 is within the angular range A. When the selection operation portion 16 is within the angular range A, that is when the song titles are displayed by scrolling (S300: YES), the CPU 11 performs processing while the song titles are displayed by scrolling (processing during the song title scroll display) (S400).

(Processing during Song Title Scroll Display)

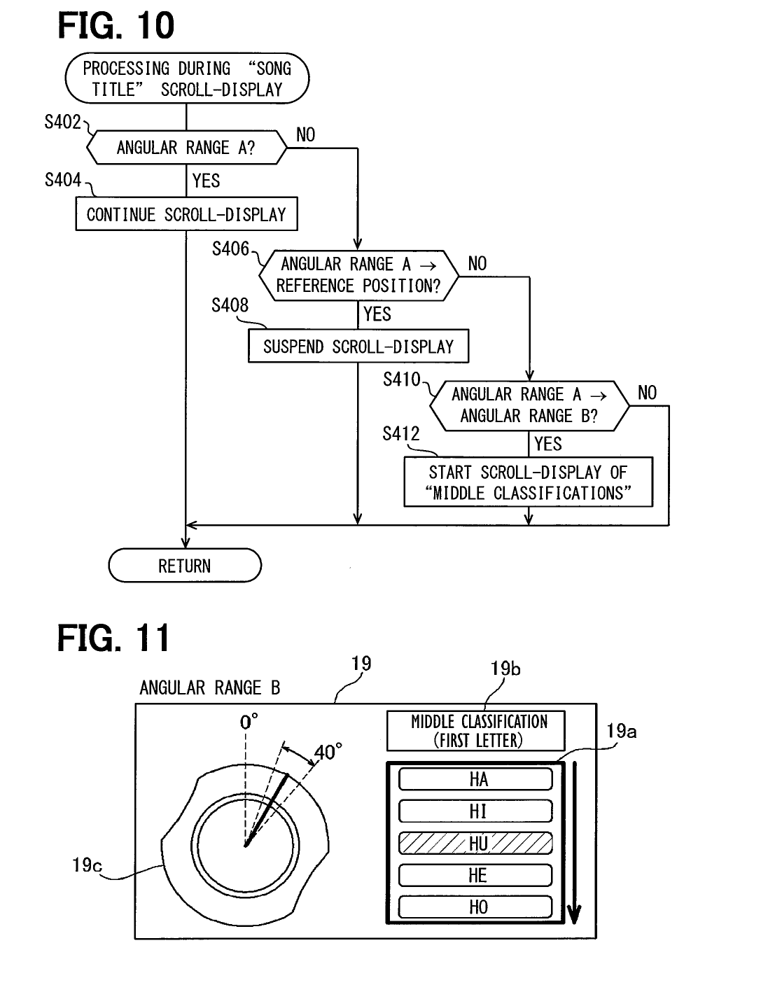

FIG. 10 is a flowchart illustrating the processing during the song title scroll display. When the CPU 11 begins the processing during the song title scroll display, the CPU 11 initially determines whether the selection operation portion 16 is within the angular range A (S402). When the selection operation portion 16 is within the angular range A (S402: YES), the CPU 11 continues the scroll display of the song titles (S404). A speed of the scroll display is set to a speed corresponding to the rotational angle (the displacement amount) of the selection operation portion 16. When the selection operation portion 16 is within the angular range A, the speed of the scroll display of the song titles increases as the rotational angle of the selection operation portion 16 becomes larger. The speed of the scroll display of the song titles decreases as the rotational angle of the selection operation portion 16 becomes smaller. According to this configuration, it may be possible for the user to start the scroll display of the song titles by rotating the selection operation portion 16 from the reference position. It may be possible for the user to increase the speed of the scroll display of the song titles by making the rotational angle larger, and to decrease the speed of the scroll display of the song titles by making the rotational angle smaller.

When the CPU 11 determines in S402 that the selection operation portion 16 is not within the angular range A (S402: NO), the CPU 11 determines whether the selection operation portion 16 is returned to the reference position from the angular range A (S406). When the selection operation portion 16 is returned to the reference position from the angular range A (S406: YES), the CPU 11 suspends the scroll display of the song titles (S408). In this case, the scroll display of the song titles is suspended while one song title is displayed as the selection candidate (as described in a slant line hatching of FIG. 5). According to this configuration, by returning the selection operation portion 16 from the angular range A to the reference position (decreasing the rotational angle), it may be possible for the user to decrease the speed of the scroll display of the song titles, and to eventually suspend the scroll display of the song titles, and one song title is displayed as the selection candidate. The selection of the song title displayed as a selection candidate is finalized when the determination button 16a is operated while the scroll display is suspended.

When the selection operation portion 16 is not returned to the reference position from the angular range A (S406: NO), the CPU 11 determines whether the selection operation portion 16 is rotated further from the angular range A to reach the angular range B (S410). When the selection operation portion 16 has reached the angular range B (S410: YES), the CPU 11 ends the scroll display of the song titles being performed and starts to display middle classifications (first letters) by scrolling (S412). When the CPU 11 ends the scroll display of the song titles and starts to display the middle classifications (first letters) by scrolling in a state where a predetermined song title is displayed as a selection candidate, the CPU 11 starts to display the middle classifications (first letters) by scrolling while a middle classification (a first letter) to which the predetermined song title corresponds (belongs) is displayed as a selection candidate. For example, when the CPU 11 ends the scroll display of the song titles in a state where a song title beginning with “HU” is displayed as a selection candidate, the CPU 11 starts to display middle classifications (first letters) by scrolling while “HU (a first letter)” is displayed as a selection candidate.

FIG. 11 shows an example in which middle classifications (first letters) are displayed on the display 19 by scrolling. As is described in FIG. 11, during the scroll display of middle classifications (first letters), the middle classifications (first letters) are displayed by scrolling in the scroll display region 19a and the rank being displayed by scrolling, which is “middle classification (the first letter)”, is displayed in the rank display region 19b. Also, as shown in FIG. 11 by a slant line hatching, one of the middle classifications (first letters) being displayed is exhibited as a selection candidate by displaying the one middle classification (a first letter) in a color different from the rest. According to this configuration, it may be possible for the user to readily identify the middle classification (the first letter) being displayed as a selection candidate.

During the scroll display of the middle classifications (first letters), the middle classifications (first letters) displayed in the scroll display region 19a are changed successively, and a middle classification (a first letter) displayed as a selection candidate is changed one after another. The image 19c indicating that the rotational angle of the selection operation portion 16 is within the angular range B is also displayed on the display 19. When a last middle classification (a first letter) (a middle classification in the lowermost parts of FIG. 3B and FIG. 3C) is displayed by scrolling (displayed as a selection candidate), the display returns to a first middle classification (a first letter) (a middle classification in the uppermost parts of FIG. 3B and FIG. 3C) and the following middle classifications (first letters) are displayed by scrolling (displayed as a selection candidate).

In the item selection apparatus 10 of the present embodiment, a speed of the scroll display of the song titles (speed at which a song title of a selection candidate is changed) increases as the rotational angle of the selection operation portion 16 becomes larger within the angular range A. When the rotational angle of the selection operation portion 16 reaches the angular range B, the scroll display of the middle classifications (first letters) (changing of a middle classification (a first letter) as a selection candidate) is started. Thus, it may be possible for a user to switch a subject to be displayed by scrolling from the song titles to the middle classifications (first letters) by merely continuing an operation to increase the speed of the scroll display (an operation to rotate the selection operation portion 16) without performing any extra operation in between. Moreover, it may be possible for a user to feel a start of the scroll display of the middle classifications (first letters) in a process of increasing the speed of the scroll display of the song titles.

When a subject to be displayed by scrolling is switched from the song titles to the middle classifications (first letters) in a state where a predetermined song title is displayed as the selection candidate, the scroll display of the middle classifications (first letters) is started while a middle classification (a first letter) to which the predetermined song title corresponds is displayed (belongs) as a selection candidate. Thus, it may be possible for the user to feel more smoothly a start of the scroll display of the middle classifications (first letters) in the process of increasing the speed of the scroll display of the song titles.

The processing while the song titles are displayed by scrolling (processing during the song title scroll display) is described. When the song titles are not displayed by scrolling (S300 of FIG. 6: NO), the CPU 11 determines whether the middle classifications (first letters) are displayed by scrolling (S500). As described above, in the item selection apparatus 10 of the present embodiment, the scroll display of the middle classifications (first letters) is started when the selection operation portion 16 is rotated to the angular range B. The scroll display of the middle classifications (first letters) is continued while the selection operation portion 16 is within the angular range B. Thus, the CPU 11 determines in S500 whether the middle classifications (first letters) are displayed by scrolling based on whether the selection operation portion 16 is within the angular range B. When, the selection operation portion 16 is within the angular range B (S500: YES), and when the middle classifications (first letters) are displayed by scrolling, the CPU 11 performs processing while the middle classifications (first letters) are displayed by scrolling (processing during middle classification scroll display) (S600).

(Processing during Middle Classification Scroll Display)

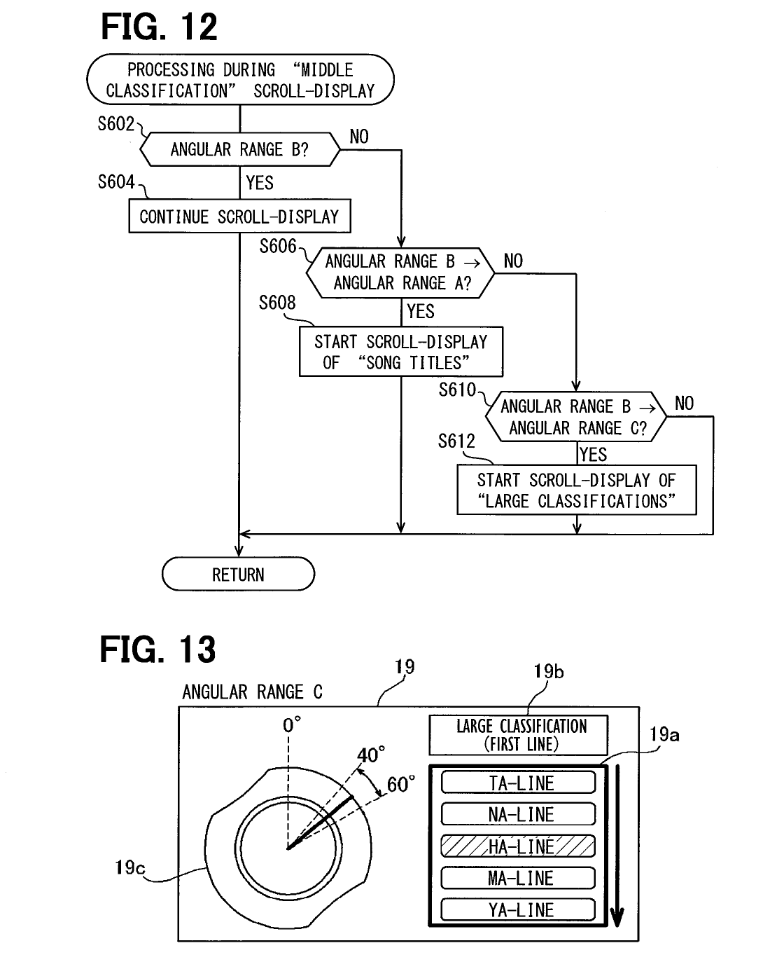

FIG. 12 is a flowchart illustrating the processing during middle classification scroll display. When the CPU 11 begins the processing during middle classification scroll display, the CPU 11 determines whether the selection operation portion 16 is within the angular range B (S602). When the selection operation portion 16 is within the angular range B (S602: YES), the CPU 11 continues the scroll display of the middle classifications (first letters) (S604). In this case, a speed of the scroll display is set to a speed corresponding to the rotational angle (the displacement amount) of the selection operation portion 16. While the selection operation portion 16 is within the angular range B, the speed of the scroll display of the middle classifications (first letters) increases as the rotational angle of the selection operation portion 16 becomes larger. The speed of the scroll display of the middle classifications (first letters) decreases as the rotational angle of the selection operation portion 16 becomes smaller. According to this configuration, it may be possible for the user to start the scroll display of the middle classifications (first letters) by rotating the selection operation portion 16 to the angular range B. it may be possible for the user to increase the speed of the scroll display of the middle classifications (first letters) by making the rotational angle larger within the angular range B, and to decrease the speed of the scroll display of the middle classifications (first letters) by making the rotational angle smaller within the angular range B.

When the CPU 11 determines in S602 that the selection operation portion 16 is not within the angular range B (S602: NO), the CPU 11 determines whether the selection operation portion 16 is returned to the angular range A from the angular range B (S606). When the selection operation portion 16 is returned to the angular range A from the angular range B (S606: YES), the CPU 11 ends the scroll display of the middle classifications (first letters) and starts to display song titles by scrolling (S608).

When the subject to be displayed by scrolling is switched from middle classifications (first letters) to song titles while a predetermined middle classification (a first letter) is displayed as a selection candidate, the CPU 11 starts to display the song titles by scrolling from a state where a song title corresponding (belonging) to the predetermined middle classification (a first letter) is displayed as a selection candidate. For example, when the subject to be displayed by scrolling is switched from the middle classifications (first letters) to the song titles in a state where the “HU (a first letter)” is displayed as the selection candidate, the CPU 11 starts to display the song titles by scrolling from a state where a song title beginning with “HU” is displayed as a selection candidate.

When the selection operation portion 16 is returned to the angular range A from the angular range B while a predetermined middle classification (a first letter) is displayed as a selection candidate, the CPU 11 does not immediately start the scroll display of the song titles. Instead, the CPU 11 maintains a state in which the first song title among the song titles corresponding to the predetermined middle classification (a first letter) is displayed as a selection candidate (the scroll display is paused) for a predetermined time, and then the CPU 11 starts to display the song titles by scrolling. According to this configuration, even when the user wishes to select a song title displayed as a selection candidate immediately (first) after the scroll display of the song titles is started, it may be possible for the user to select the desired song title easily since a state in which the desired song title is displayed as a selection candidate is maintained for the predetermined time.

Even when the scroll display of the song titles is started, when the selection operation portion 16 is returned to the reference position, the scroll display of the song titles is suspended while one song title is displayed as a selection candidate as the processing in S408 of FIG. 10 is performed. When the determination button 16a is operated in this state, a selection of the song title being displayed as a selection candidate is finalized as the processing in S206 of FIG. 7. A song under the selected song title is played.

In the item selection apparatus 10 of the present embodiment, the speed of the scroll display of the middle classifications (first letters) (a speed at which a middle classification (a first letter) of a selection candidate changed) decreases as the rotational angle of the selection operation portion 16 becomes smaller within the angular range B. When the rotational angle of the selection operation portion 16 is returned to the angular range A, the scroll display of the song titles (changing of a song title of a selection candidate) is started. Thus, it may be possible for the user to switch the subject to be displayed by scrolling from the middle classifications (first letters) to the song titles by merely continuing an operation to decrease the speed of the scroll display (an operation to rotate the selection operation portion 16) without performing any extra operation in between. Moreover, it may be possible for the user to feel that the scroll display of the song titles is started in the process of decreasing a speed of the scroll display of the middle classifications (first letters).

When the subject to be displayed by scrolling is switched from the middle classifications (first letters) to the song titles while a predetermined middle classification (a first letter) is displayed as a selection candidate, the scroll display of the song titles is started from a state where a song title corresponding (belonging) to the predetermined middle classification (a first letter) is displayed as a selection candidate. Thus, it may be possible for the user to cause the song titles belonging to a desired middle classification (a first letter) being displayed by scrolling (displayed as a selection candidate) smoothly and intuitively.

Thus, it may possible to reduce a burden on the user when selecting a song title.

When the CPU 11 determines in S606 that the selection operation portion 16 is not returned to the angular range A from the angular range B (S606: NO), the CPU 11 determines whether the selection operation portion 16 is rotated further from the angular range B to reach the angular region C (S610). When the selection operation portion 16 reaches the angular range C (S610: YES), the CPU 11 ends the scroll display of the middle classifications (first letters), and starts to display the large classifications (first lines) by scrolling (S612). When the subject to be displayed by scrolling is switched from the middle classifications (first letters) to the large classifications (first lines) while a predetermined middle classification (a first letter) is displayed as a selection candidate, the CPU 11 starts to display the large classifications (first lines) by scrolling while a large classification (a first line) corresponding to the predetermined middle classification (a first letter) (to which the predetermined middle classification (a first letter) belongs) is displayed as a selection candidate. For example, when the subject to be displayed by scrolling is switched from the middle classifications (first letters) to the large classifications (first lines) while “HU (a first letter)” is displayed as a selection candidate, the CPU 11 starts to display the large classifications (first lines) by scrolling while “HA-line (a first line)” is displayed as a selection candidate.

FIG. 13 shows an example in which the large classifications (first lines) are displayed on the display 19 by scrolling. As shown in FIG. 13, during the scroll display of the large classifications (first lines), the large classifications (first lines) are displayed by scrolling in the scroll display region 19a and the rank being displayed by scrolling, which is “large classifications (first lines)”, is displayed in the rank display region 19b. As is shown in FIG. 13 by a slant line hatching, one of the large classifications (first lines) being displayed is exhibited as a selection candidate by displaying the one large classification (first lines) in a color different from the rest. According to this configuration, it may be possible for the user to easily identify a large classification (first lines) being displayed as a selection candidate.

During the scroll display of the large classifications (first lines), the large classifications (first lines) displayed in the scroll display region 19a are changed successively. The large classification (a first line) displayed as a selection candidate is changed one after another. The image 19c indicating that the rotational angle of the selection operation portion 16 is within the angular range C is also displayed on the display 19. When a last large classification (a first line) (a large classification in the lowermost parts of FIG. 3B and FIG. 3C) is displayed by scrolling (displayed as a selection candidate), the display returns to a first large classification (a first line) (a large classification in the uppermost parts of FIG. 3B and FIG. 3C) and the following large classifications (first lines) are displayed by scrolling (displayed as a selection candidate).

Thus, in the item selection apparatus 10 of the present embodiment, the speed of the scroll display of the middle classifications (first letters) (speed at which a middle classification (a first letter) of a selection candidate is changed) increases as the rotational angle of the selection operation portion 16 becomes larger within the angular range B. When the rotational angle of the selection operation portion 16 reaches the angular range C, the scroll display of the large classifications (first lines) (changing of a large classification (a first line) as a selection candidate) is started. Therefore, it may be possible for the user to switch the subject to be displayed by scrolling from the middle classifications (first letters) to the large classifications (first lines) by merely continuing an operation to increase the speed of the scroll display (an operation to rotate the selection operation portion 16) without performing any extra operation in between. Moreover, it may be possible for the user to feel a start of the scroll display of the large classifications (first lines) in the process of increasing the speed of the scroll display of the middle classifications (first letters).

When the subject to be displayed by scrolling is switched from the middle classifications (first letters) to the large classifications (first lines) while a predetermined middle classification (a first letter) is displayed as a selection candidate, the scroll display of the large classifications (first lines) is started from a state where a large classification (a first line) corresponding to the predetermined middle classification (a first letter) (to which the predetermined middle classification (a first letter) belongs) is displayed as a selection candidate. Therefore, it may be possible for the user to feel more smoothly a start of the scroll display of the large classifications (first lines) in the process of increasing a speed of the scroll display of the middle classifications (first letters).

The processing while the middle classifications (first letters) are displayed by scrolling (processing during the middle classification scroll display) is described. When the middle classifications (first letters) are not displayed by scrolling (S500 of FIG. 6: NO), the CPU 11 determines whether the large classifications (first lines) are displayed by scrolling (S700). As described above, in the item selection apparatus 10 of the present embodiment, the scroll display of the large classifications (first lines) is started when the selection operation portion 16 is rotated to the angular range C. The scroll display of the large classifications (first lines) is continued while the selection operation portion 16 is within the angular range C. The CPU 11 determines in S700 whether the large classifications (first lines) are displayed by scrolling based on whether the selection operation portion 16 is within the angular range C. When the selection operation portion 16 is within the angular range C (S700: YES), and when the large classifications (first lines) are displayed by scrolling, the CPU 11 performs processing while the large classifications (first lines) are displayed by scrolling (processing during the large classification scroll display) (S600).

(Processing during Large Classification Scroll Display)

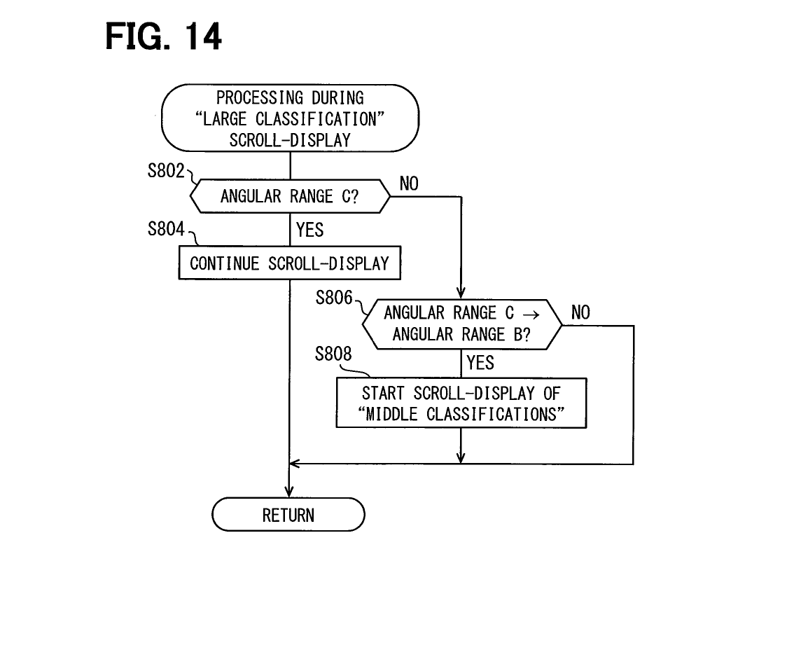

FIG. 14 is a flowchart illustrating the processing during the large classification scroll display. When the CPU 11 begins the processing during the large classification scroll display, the CPU 11 determines whether the selection operation portion 16 is within the angular range C (S802). When the selection operation portion 16 is within the angular range C (S802: YES), the CPU 11 continues the scroll display of the large classifications (first lines) (S804). A speed of the scroll display is set to a speed corresponding to the rotational angle (the displacement amount) of the selection operation portion 16. That is, while the selection operation portion 16 is within the angular range C, the speed of the scroll display of the large classifications (first lines) increases as the rotational angle of the selection operation portion 16 becomes larger. The speed of the scroll display of the large classifications (first lines) decreases as the rotational angle of the selection operation portion 16 becomes smaller. According to this configuration, it may be possible for the user to start the scroll display of the large classifications (first lines) by rotating the selection operation portion 16 to the angular range C. Therefore, it may be possible for the user to increase the speed of the scroll display of the large classifications (first lines) by causing the rotational angle to be larger within the angular range C and to decrease the speed of the scroll display of the large classifications (first lines) by causing the rotational angle to be smaller within the angular range C.

When the CPU 11 determines in S802 that the selection operation portion 16 is not within the angular range C (S802: NO), the CPU 11 determines whether the selection operation portion 16 is returned to the angular range B from the angular range C (S806). When the selection operation portion 16 is returned to the angular range B from the angular range C (S806: YES), the CPU 11 ends the scroll display of the large classifications (first lines) being performing, and starts to display the middle classifications (first letters) again by scrolling (S808).

When the subject to be displayed by scrolling is switched from the large classifications (first lines) to the middle classifications (first letters) while a predetermined large classification (a first line) is displayed as a selection candidate, the CPU 11 starts to display the middle classifications (first letters) by scrolling while a middle classification (a first letter) corresponding (belonging) to the predetermined large classification (a first line) is displayed as a selection candidate. For example, when the subject to be displayed by scrolling is switched from large classifications (first lines) to the middle classifications (first letters) while a “HA-line (a first line)” is displayed as a selection candidate, the CPU 11 starts to display the middle classifications (first letters) while “HA (a first letter)” is displayed as a selection candidate.

When the selection operation portion 16 is returned to the angular range B from the angular range C while a predetermined large classification (a first line) is displayed as a selection candidate, the CPU 11 does not immediately start the scroll display of the middle classifications (first letters). Instead, the CPU 11 maintains a state in which a first middle classification (a first letter) among the middle classifications (first letters) corresponding to the predetermined large classification (a first line) is displayed as a selection candidate for a predetermined time (after the scroll display is paused), and then the CPU 11 starts to display the middle classifications (first letters) by scrolling.

Even when the scroll display of the middle classifications (first letters) is started, when the selection operation portion 16 is returned to the angular range A, the processing in S608 of FIG. 12 is performed, the scroll display of the middle classifications (first letters) is suspended, and the scroll display of the song titles is started. Further, when the selection operation portion 16 is returned to the reference position, the processing in S408 of FIG. 10 is performed, and the scroll display of the song titles is suspended. In this state, one song title is displayed as a selection candidate. When the determination button 16a is operated, a selection of a song title displayed as a selection candidate is finalized as the processing in S206 of FIG. 7 is performed. Consequently, a song under the selected song title is played. According to this configuration, even when the user wishes to select a middle classification (a first letter) displayed as a selection candidate immediately (first) after the scroll display of the middle classifications (first letters) is started, it may be possible for the user to easily select the desired middle classification (a first letter) since the desired middle classification (a first letter) is displayed as a selection candidate for a predetermined time.

In the item selection apparatus 10 of the present embodiment, a speed of the scroll display of the large classifications (first lines) (speed at which a large classification (a first line) of a selection candidate is changed) is decreased by causing the rotational angle of the selection operation portion 16 smaller from the angular range C, and the scroll display of the middle classifications (first letters) is started (a song title of a selection candidate is changed) when the rotational angle of the selection operation portion 16 is returned to the angular range B. It may be possible for the user to switch the subject to be displayed by scrolling from the large classifications (first lines) to the middle classifications (first letters) by merely continuing an operation to decrease a speed of the scroll display (an operation to rotate the selection operation portion 16) without performing any extra operation in between. Moreover, it may be possible for the user to feel a start of the scroll display of the middle classifications (first letters) in the process of decreasing the speed of the scroll display of the large classifications (first lines).

When the subject to be displayed by scrolling is switched from the large classifications (first lines) to the middle classifications (first letters) while a predetermined large classification (a first line) is displayed as a selection candidate, the scroll display of the middle classifications (first letters) is started while a middle classification (a first letter) corresponding (belonging) to the predetermined large classification (a first line) is displayed as a selection candidate. It may be possible for the user to display the middle classifications (first letters) belonging to the desired large classification (a first line) by scrolling (displayed as a selection candidate) smoothly and intuitively.

Therefore, it may be possible to reduce a burden on the user when selecting a song title.

The item selection apparatus 10 of the present embodiment displays song titles, first letters, and lines by scrolling, and therefore it is unnecessary to display song titles to be probable selection candidates, first letters to be probable selection candidates, and lines to be probable selection candidates, on the display 19 at one time. Thus, even when the number of song titles to be probable selection candidates, first letters to be probable selection candidates, and lines to be probable selection candidates is increased, it may be possible to display these on the display 19 in a manner easy to confirm for the user.

Incidentally, the item selection apparatus 10 of the present embodiment stores the hierarchical data in which multiple song titles (items) are divided into multiple middle classifications (first letters) (groups). The item selection apparatus 10 displays the multiple song titles (items) on the display 19 (a display screen). The item selection apparatus 10 changes the middle classification (a first letter) (corresponding to a group of the present disclosure) in which the song title (corresponding to an item of the present disclosure) is displayed. According to this manner, the item selection apparatus 10 causes a user to select a desired song title on the display 19 (a display screen).

The selection operation portion 16 of the present embodiment has a predetermined reference position and is rotated (displaced) from the reference position when a rotational operation (a predetermined operation) is made. The selection operation portion 16 of the present embodiment corresponds to an operation portion of the present disclosure.

The CPU 11 of the present embodiment displays a song title (an item) of a selection candidate among multiple song titles (items) displayed on the display 19 (a display screen) in a mode different from the other song titles (items). The display 19 corresponds to a display screen. The CPU 11 and S200 correspond to a selection candidate display portion (or means) of the present disclosure. When the selection operation portion 16 (an operation portion) is rotated (displaced) from the reference position, the CPU 11 changes the song title (an item) of the selection candidate displayed on the display 19 (a display screen) at a speed corresponding to the rotational angle (the displacement amount) from the reference position. A song title of the present embodiment corresponds to an item of the present disclosure. The rotational angle corresponds to a displacement amount. The CPU 11 and S400 correspond to a selection candidate change portion (or means) of the present disclosure. When the determination button 16a is operated (when a predetermined determination operation is performed) while the selection operation portion 16 (operation portion) is at the reference position, the CPU 11 of the present embodiment determines the song title (an item) of the selection candidate to be a song title (an item) for which a selection is finalized (which is selected). The CPU 11 and S204 correspond to a determination portion (or means) of the present disclosure. When the rotational angle (the displacement amount) of the selection operation portion 16 (the operation portion) from the reference position is within the angular range B (exceeds a predetermined threshold amount of displacement), the CPU 11 changes a middle classification (a first letter) (a group) in which multiple song titles (items) are displayed on the display 19 (the display screen), and displays the changed middle classification (a first letter) (a group) in a color (a mode) different from the other middle classifications (first letters) (groups). Middle classifications (first letters) of the present embodiment correspond to groups of the present disclosure. The CPU 11 changes a middle classification (a first letter) (a group) at a higher speed as the rotational angle (the displacement amount) of the selection operation portion 16 (the operation portion) becomes larger (over the threshold amount of displacement) within the angular range B. The CPU 11 and S600 correspond to a group change portion (or means) of the present disclosure. The CPU 11 displays multiple song titles (items) on the display 19 (a display screen) by scrolling. The CPU 11 and S300 correspond to a scroll portion (or means) of the present disclosure.

(Modifications)

(First Modification)

The item selection apparatus 10 in the above embodiment suspends the scroll display of the song titles when the selection operation portion 16 is returned to the reference position while the song titles are displayed by scrolling, and determines a selection of a displayed song title of a selection candidate when the determination button 16a is operated while the scroll display of song titles is suspended.

Alternatively, when the selection operation portion 16 is returned to the reference position while the song titles are displayed by scrolling, the scroll display of the song titles may be suspended and a selection of a displayed song title of a selection candidate may be finalized. Thus, a selection of a song title may be finalized when the selection operation portion 16 is returned to the reference position even when the determination button 16a is not operated.

According to this configuration, a selection of a song title is finalized with only an operation to suspend the scroll display of the song titles.

(Second Modification)

In the above embodiment, a direction of the scroll display is not particularly specified. However, when the selection operation portion 16 is rotated backward toward the reference position while items (song titles) or groups (middle classifications or large classifications) are displayed by scrolling, the items (the song titles) or the groups (the middle classifications or the large classifications) may be displayed by scrolling backward.

For example, it is supposed that the rotational angle of the selection operation portion 16 is made larger to the extent that the rotational angle of the selection operation portion 16 is within the angular range A and the song titles are displayed by scrolling downward. In this case, the song titles may be displayed by scrolling upward when the rotational angle is made smaller. According to this configuration, even when the display of a desired item (a song title) or a group (a middle classification or a large classification) of a selection candidate ends while items (song titles) or groups (middle classifications or large classifications) are displayed by scrolling, the desired item (song title) or the desired group (middle classification or large classification) is displayed again as a selection candidate by scrolling backward.

(Third Modification)

In the above embodiment, a song title is selected. The user may select other categories such as an artist name, an album title in addition to a song title. For example, before the item selection processing described above is performed, the user may select a category in which an item the user wishes to select is present from a song title category, an artist name category, and an album title category.

In this case, the number of ranks may be different among the categories. For example, the song title category may have three ranks: a song title, a middle classification (a first letter), and a large classification (a first line). The artist name category may have two ranks: an artist name and a large classification (a musical genre). The album title category may have four ranks: an album name, a small classification (a first letter), a middle classification (a first line), and a large classification (a musical genre). In such a case, angular ranges of the selection operation portion 16 are set for each category.

For example, when the artist name category having two ranks is selected, the artist names are displayed by scrolling when the rotational angle is greater than 0 degrees and less than 30 degrees, and the large classifications (the musical genres) are displayed by scrolling when the rotational angle is 30 degrees or greater and 60 degrees or less. When the album title category having four ranks is selected, the album titles are displayed by scrolling when the rotational angle is greater than 0 degree and less than 15 degrees, the small classifications (first letters) are displayed by scrolling when the rotational angle is 15 degrees or greater and less than 30 degrees, the middle classifications (first lines) are displayed by scrolling when the rotational angle is 30 degrees or greater and less than 45 degrees, and the large classifications (the musical genres) are displayed by scrolling when the rotational angle is 45 degrees or greater and 60 degrees or less.

According to this configuration, even when an item is selected from categories each having a different number of ranks, it may be possible to select the item from the respective categories by the similar operation (an operation to rotate the selection operation portion 16).

While the embodiment and the modifications of the item selection apparatus 10 have been described, it should be appreciated that the present disclosure is not limited to the embodiment and the modifications described above and can be implemented in various manners within the scope of the present disclosure.

For example, in the above embodiment, the rotatable selection operation portion 16 is an operation portion for selecting an item. However, a swingable operation portion such a joystick, or a slidable operation portion such as a slide switch may be provided instead. When the swingable operation portion or the slidable operation portion is provided, a speed of the scroll display of items (song titles) may be increased as the amount of swing motion or the amount of sliding motion increases, and a subject to be displayed by scrolling may be switched to groups (middle classifications) when an amount of swing motion or an amount of sliding motion reaches a first predetermined amount. When the amount of swing motion or the amount of sliding motion is decreased to a second predetermined amount while a predetermined group is selected, the subject to be displayed by scrolling is switched to items included in the predetermined group.

In the above embodiment, the respective ranks are displayed by scrolling. However, when items or groups to be probable selection candidates can be displayed at one time within a display region of the display 19, the items or the groups are unnecessary to display by scrolling and may be merely displayed as a selection candidate by successively switching items or groups.

When the rotational angle of the selection operation portion 16 is returned to the angular range B from the angular range C, and when the large classification (the first line) that is displayed as a selection candidate is selected, the middle classifications (first letters) belonging to the selected large classification (the first line) alone may be displayed by scrolling.

When the rotational angle of the selection operation portion 16 is returned to the angular range A from the angular range B, and when the middle classification (the first letter) that is displayed as a selection candidate is selected, the song titles beginning with the selected middle classification (a first letter) alone may be displayed by scrolling.

In the above embodiment, the subject to be displayed by scrolling is song titles, first letters, and lines. However, the present disclosure is not limited to the above configuration and the subject to be displayed by scrolling may be various items and groups. For example, the subjects may be addresses, telephone numbers, e-mail addresses, facility names, or the like that are stored in various devices such as a GPS system, a cell phone.

According to an item selection apparatus and an item selection method of the present disclosure, an item of a selection candidate among multiple items displayed on a display screen is displayed in a mode different from other items. When a predetermined determination operation is performed while an operation portion is at a reference position, the item of a selection candidate is determined to be a selected item. When the operation portion is displaced from the reference position, the item of a selection candidate displayed on the display screen is changed at a speed corresponding to the displacement amount from the reference position. When the displacement amount of the operation portion from the reference position exceeds a predetermined threshold amount of displacement, a group with which multiple items are displayed on the display screen is changed.

According to the present disclosure, an item selection apparatus, in which multiple items are stored by classifying the multiple items into multiple groups to let a user select a desired item on a display screen by displaying the multiple items on the display screen while changing a group with which the items are displayed. The item selection apparatus includes: an operation portion that has a predetermined reference position and is displaced from the reference position when a predetermined operation is made; a selection candidate display portion that displays an item of a selection candidate among the multiple items displayed on the display screen in a mode different from the other items; a selection candidate change portion that changes the item of a selection candidate displayed on the display screen at a speed corresponding to the displacement amount from the reference position when the operation portion is displaced from the reference position; a determination portion that determines the item of a selection candidate as a selected item when a predetermined determination operation is performed while the operation portion is at the reference position; and a group change portion that changes the group with which the multiple items are displayed on the display screen when the displacement amount of the operation portion from the reference position exceeds a predetermined threshold amount of displacement.

Further, according to the present disclosure, an item selection method, by which multiple items are stored by classifying the multiple items into multiple groups to let a user select a desired item on a display screen by displaying the multiple items on the display screen while changing a group with which the items are displayed, is provided. The item selection method includes: displaying an item of a selection candidate among the multiple items displayed on the display screen in a mode different from the other items; changing the item of a selection candidate displayed on the display screen at a speed corresponding to a displacement amount from the reference position when the operation portion is displaced from a reference position; settling the item of a selection candidate to be a selected item when a predetermined determination operation is performed while the operation portion is at the reference position; and changing the group with which the multiple items are displayed on the display screen when the displacement amount of the operation portion from the reference position exceeds a predetermined threshold amount of displacement. According to the item selection apparatus and the item selection method of the present disclosure, a changing speed of an item of a selection candidate increases as a displacement amount of the operation portion increases, and a group with which multiple items are displayed on the display screen is changed when the displacement amount of the operation portion exceeds the predetermined threshold amount of displacement. Therefore, it may be possible for the user to switch subject to be changed from an item of a selection candidate to a group with which multiple items are displayed on the display screen by merely continuing an operation to increase a changing speed of a selection candidate (an operation to increase the displacement amount of the operation portion) without performing any extra operation in between. Moreover, it may be possible to cause the user to feel a change of a group with which multiple items are displayed on the display screen in a process of increasing a changing speed of an item of a selection candidate. Consequently, it may be possible for the user to change an item of a selection candidate smoothly and intuitively, and it may be possible to reduce a burden on the user when selecting an item.

The item selection apparatus of the present disclosure may display the group with which the multiple items are displayed on the display screen in a mode different from the other groups when the displacement amount of the operation portion exceeds the threshold amount of displacement.

According to this configuration, it may be possible for the user to readily identify a group with which multiple items are displayed on the display screen and it may be possible to reduce a burden on the user when selecting an item further.

The item selection apparatus in the present disclosure may display a group with which multiple items are displayed on the display screen at a higher speed as the displacement amount of the operation portion becomes larger than the threshold amount of displacement.

According to this configuration, it may be possible for the user to increase a changing speed of a group with which multiple items are displayed on the display screen by continuing an operation to increase the displacement amount of the operation portion after a displacement amount exceeds the threshold amount of displacement. Moreover, it may be possible for the user to feel a change of a group with which multiple items are displayed on the display screen and an increase of the changing speed when a changing speed of an item of a selection candidate increases. Consequently, it may be possible for the user to change a group with which multiple items are displayed on the display screen smoothly and intuitively and thus a burden on the user when selecting an item can be reduced further.

The item selection apparatus of the present disclosure may display the multiple items on the display screen while scrolling.

According to this configuration, it may become unnecessary to display items as probable selection candidates on the display screen at one time. Therefore, even when the number of items as probable selection candidates is increased, it may be possible to display the items on the display screen in a size easy to confirm for the user. Consequently, it may be possible to reduce a burden on the user when selecting an item further.

According to the item selection apparatus of the present disclosure, the operation portion may be provided in a rotatable manner and the operation portion may be displaced from the reference position when rotated.

According to this configuration, when the user operates the operation portion, it is possible to correlate the displacement amount (the rotational angle) of the operation portion with the amount of twist of the wrist. As compared with a case where the operation portion is merely moved linearly, it may be possible for a user to feel the displacement amount of the operation portion more easily. Consequently, it may be possible to reduce a burden on the user when selecting an item further.

Incidentally, the flowcharts described herein or processing in the flowcharts is formed of multiple sections (or referred to as steps), and each section is denoted as, for example, S100. Further, each section may be divided into more than one sub-section. Conversely, two or more sections may be combined into one section. Furthermore, each section formed as above may be referred to also as a device, a module, or means.

While the embodiment, the configuration, and the aspect of the present disclosure are exemplified, but the embodiment, the configuration, and the aspect according to the present disclosure are not limited to each of the embodiment, configuration, and aspect. For example, an embodiment, a configuration, and an aspect which are obtained by appropriately combining technical parts disclosed in each of different embodiment, configuration, and aspect are also included in the scope of the embodiment, the configuration, and the aspect according to the present disclosure.

What is claimed is:

1. An item selection apparatus storing a plurality of items being classified into a plurality of groups, and selecting a desired item on a display screen by displaying the plurality of items on the display screen and by changing a group with which the items are displayed, the item selection apparatus comprising:
an operation portion that has a predetermined reference position and rotated from the reference position when a rotation operation is made;
a selection candidate display portion that displays an item of a selection candidate among the plurality of items displayed on the display screen in a mode different from an other item;
a selection candidate change portion that, when the operation portion is rotated from the reference position, changes the item of the selection candidate displayed on the display screen at a speed corresponding to a rotational angle from the reference position;
a determination portion that determines the item of the selection candidate as a selected item when a predetermined determination operation is made while the operation portion is at the reference position; and
a group change portion that, when the rotational angle of the operation portion from the reference position exceeds a predetermined threshold angle, changes the group with which the plurality of items are displayed on the display screen.

2. The item selection apparatus according to claim 1, wherein:
the group change portion displays the group with which the plurality of items are displayed on the display screen in a mode different from an other group when the rotational angle of the operation portion from the reference position exceeds the threshold angle.

3. The item selection apparatus according to claim 1, wherein:
the group change portion changes the group with which the plurality of items are displayed on the display screen at a higher speed as the rotational angle of the operation portion becomes larger over the threshold angle.

4. The item selection apparatus according to claim 1, further comprising:
a scroll portion that displays the plurality of items on the display screen by scrolling.

5. An item selection method selecting a desired item on a display screen by displaying the plurality of items on the display screen and by changing a group with which the items are displayed, wherein a plurality of items being classified into a plurality of groups are stored, the item selection method comprising:
displaying an item of a selection candidate among the plurality of items displayed on the display screen in a mode different from an other item;
changing the item of the selection candidate displayed on the display screen at a speed corresponding to a rotational angle from a reference position when a rotational operation is made and an operation portion is rotated from the reference position;
determining the item of the selection candidate as a selected item when a predetermined determination operation is made while the operation portion is at the reference position; and
changing the group with which the plurality of items are displayed on the display screen when the rotational angle of the operation portion from the reference position exceeds a predetermined threshold angle.

6. (canceled)
